(19) United States
(12) Patent Application Publication
(10) Pub. No.: US 2020/0151782 A1
(43) Pub. Date: May 14, 2020

(54) APPARATUS AND METHOD FOR GENERATING NEUTRAL DATA FOR A PRODUCT SPECIFICATION

(71) Applicant: PHOENIX CONTACT GmbH & Co. KG, Blomberg (DE)

(72) Inventors: Peter Keller, Oerlinghausen (DE); Matthias Tieben, Bad Salzuflen (DE); Jörg Schmidt, Petershagen (DE); Jens Frenser, Detmold (DE)

(21) Appl. No.: 16/678,764

(22) Filed: Nov. 8, 2019

(30) Foreign Application Priority Data
Nov. 9, 2018 (DE) 102018219173.5

(51) Int. Cl. G06Q 30/06; G06F 16/25; G06F 16/21; G06F 16/28

(52) U.S. Cl. CPC G06Q 30/0601; G06F 16/288; G06F 16/212; G06F 16/258

(57) ABSTRACT

The present invention concerns a process for generating neutral data for a product specification, the process being carried out in a computer network and comprising the following process steps: configuring (S1) and providing the product specification; semantizing (S2) product model data for a plurality of different product specifications from a database into semantized product model data, the database providing a plurality of product model data by variant modeling; orchestrating (S3) data processing processes of the product model data into orchestrated data processing processes; and transforming (S4) the semantized product model data by means of the orchestrated data processing processes based on the configured product specification to the neutral data of the product specification.

### TECHNICAL FIELD

The present invention relates to systems for data generation by standardized data generation processes and corresponding data generation procedures for computer-aided manufacturing.

In particular, the present invention concerns a device and a method for generating neutral data for a product specification.

### TECHNICAL BACKGROUND

Product data is available in a company in the area of product procurement, production and distribution. A continuous implementation of extensive data availability and data transformation is difficult.

### SUMMARY OF THE INVENTION

It is an object of the present invention to provide an improved device and method for generating neutral data for a product specification.

The object is solved by the subject matter of the independent patent claims. Further embodiments can be found in the dependent patent claims, the description and the figures of the drawings.

A first aspect of the present invention relates a method of generating neutral data for a product specification, the method comprising the following steps.

As a first process step, the product specification is configured and made available.

As a second process step, product model data for a large number of different product specifications is semantized from a database into semantized product model data, whereby the database provides a large number of product model data through variant modeling.

As a third process step, data processing processes of the product model data are orchestrated into orchestrated data processing processes.

As a fourth step, the semantized product model data is transformed into the neutral data of the product specification by means of the orchestrated data processing processes based on the configured product specification.

The present invention enables the generation and provision of neutral data from a configuration, wherein all information required for the business process handling can be digitally derived via an orchestration for production plants and back-end systems, covering new products, existing products and customer-specific products and product variants.

The present invention enables to react in an adapted and fully automatically adapted way to different configuration scenarios of a production specification, e.g. during product manufacturing or further data processing.

Advantageous embodiments of the present invention can be found in the dependent claims.

In an advantageous embodiment of the present invention it is intended that the procedure is executed by a distributed processing in the computer network, for example the computer network is designed as a distributed and/or decentralized computer system.

In an advantageous embodiment of the present invention it is intended that the product specification is used in terms of:
i) a customer-specific product specification; and/or
(ii) a stock product specification; and/or
(iii) a new product specification

In an advantageous embodiment of this invention, it is intended that the configuration of the product specification is carried out by a web configurator for customer-specific product configuration, a web shop, a simulation system, an enterprise resource planning system, a production control system, or an assembly auxiliary machine.

In an advantageous embodiment of the present invention, it is intended that the product model data be semantified for the multitude of different product specifications based on an entity relationship model.

In an advantageous embodiment of the present invention, it is intended that the variant modeling is provided by a web-based and/or interactive product configurator.

In an advantageous embodiment of the present invention, it is provided that the neutral data is provided in a neutral data format, the neutral data format being:
(i) an XML format; and/or
(ii) a platform-independent data format; and/or
(iii) an implementation-independent data format; and/or
(iv) a M2M data format.

The M2M data format can be adapted as a need-specific format for machines, processes and procedures to the respective data processing equipment used, which can have different requirements for the neutral data format.

The term “M2M” as used by the present invention refers to “machine-to-machine” and defines the automated exchange of information between terminal devices such as machines, automats, or production machines among themselves or with a central computer unit, server, of the computer network as a distributed and/or decentralized computer system.

In an advantageous embodiment of the present invention it is envisaged that for the orchestration of the data processing processes the data processing services of a production plant and/or a backend system of the computer network are orchestrated. The backend system may comprise different data processing equipment.

In a second aspect of the present invention, a device for generating neutral data for a product specification is provided, the device comprising a configuration module, a semantic module, and an orchestration module and a transformation module:

The configuration module is adapted to configure and provide a product specification.

The semantic module is adapted to semanticize product model data for a plurality of different product specifications into semanticized product model data from a database coupled to the computer network, the database comprising a plurality of product model data generated by variant modeling.

The orchestration module is designed to orchestrate data processing processes of the product model data into orchestrated data processing processes.

The transformation module is designed to transform semantic product model data into neutral product specification data using the orchestrated data processing processes based on the configured product specification.

In an advantageous execution form of the present invention it is intended that the device is designed as a distributed computer network.

In an advantageous embodiment of the present invention, it is provided that the configuration module is formed as the product specification in terms of:
i) a customer-specific product specification; and/or
(ii) a the stock product specification; and/or
(iii) a new product specification
to be made available.

In an advantageous embodiment of the present invention, it is provided that the configuration module is adapted to perform configuration and provision of the product specification by a web configurator, a web shop, a simulation system, an enterprise resource planning system, a production control system, or an assembly auxiliary machine.

In an advantageous embodiment of the present invention, the semantic module is designed to semanticize the product model data for the plurality of different product specifications based on an entity relationship model.

In an advantageous embodiment of the present invention, it is provided that the apparatus is adapted to provide the neutral data in a neutral data format, wherein the neutral data format includes
(i) an XML format; and/or
(ii) a platform-independent data format; and/or
(iii) an implementation-independent data format; and/or
(iii) a M2M data format

In a third aspect of the present invention, a computer network system is provided comprising the apparatus for generating neutral data for a product specification according to the second aspect of the present invention, further comprising a database having a web-based and/or interactive product configurator adapted to generate the plurality of product model data by variant modeling.

In a fourth aspect of the present invention, a computer program or computer program product is provided comprising instructions which, when the program is executed by a computer, cause the computer to execute the steps of the method of generating neutral data in a computer network in accordance with the first aspect of the present invention.

In a fifth aspect of the present invention, a computer-readable (storage) medium is provided comprising instructions which, when executed by a computer, cause the computer to execute the steps of the method of generating neutral data in a computer network in accordance with the first aspect of the present invention.

The described embodiments and implementations of the present invention can be combined arbitrarily.

Further possible embodiments and implementations of the present invention also include combinations of features of the present invention described before or in the following with regard to the embodiments and implementations of the present invention, which are not explicitly mentioned.

The enclosed drawings are intended to convey a further understanding of the embodiments of the present invention.

The enclosed drawings are intended to convey a further understanding of the embodiments and implementations in which the present invention is carried out.

The attached drawings illustrate embodiments and implementations and serve in connection with the description to explain concepts of the present invention.

Other forms embodiments and implementations and many of the advantages mentioned result from the figures in the drawings. The elements depicted in the figures in the drawings are not necessarily to scale.

### BRIEF DESCRIPTION OF THE FIGURES

FIG. 1: shows a schematic representation of a device for generating neutral data for a product specification according to an embodiment of the present invention;

FIG. 2: shows a schematic representation of a flow diagram of a process for generating neutral data for a product specification according to an embodiment of the present invention; and

FIG. 3 shows a schematic representation of a process visualisation of a process for generating neutral data for a product specification according to an embodiment of the present invention.

### DETAILED DESCRIPTION OF THE DESCRIBED EMBODIMENT

In the figures in the drawings, identical reference symbols denote identical or functionally identical elements, components, parts or process steps, unless otherwise indicated.

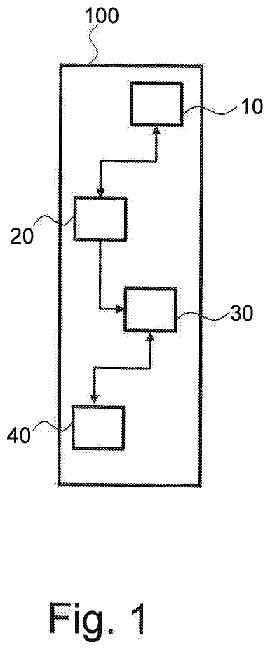

FIG. 1 shows a schematic representation of a device for generating neutral data in a computer network according to an embodiment of the present invention.

The device 100 comprises a configuration module 10, a semantic module 20, and an orchestration module 30 and a transformation module 40.

The configuration module 10 is adapted to configure and provide a product specification.

The semantic module 20 is adapted to semanticize product model data for a plurality of different product specifications into semanticized product model data from a database coupled to the computer network, the database comprising a plurality of product model data generated by variant modeling.

In other words, the semantic module 20 is adapted to determine semantic relationships between captured functions of individual computers of the computer network.

The orchestration module 30 is adapted to perform orchestration and to orchestrate data processing processes of the product model data into orchestrated data processing processes.

The transformation module 40 is designed to transform semantized product model data into the neutral data of the product specification by means of the orchestrated data processing processes based on the configured product specification.

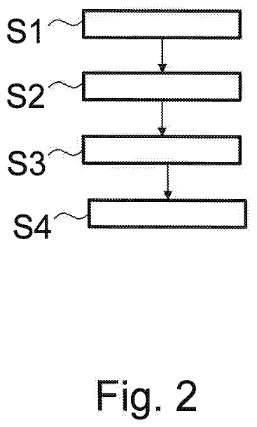

FIG. 2 is a schematic representation of a flow diagram of a process for generating neutral data for a product specification according to an embodiment of the present invention.

As a first process step, configuring S1 and providing of the product specification is conducted.

As a second process step, semanticizing S2 of product model data for a multitude of different product specifications from a database to semantized product model data is conducted, wherein the database provides a multitude of product model data through variant modeling.

As a third process step, orchestrating S3 of the data processing processes of the product model data into orchestrated data processing processes is conducted.

Orchestrating S3 includes, for example, an orchestration in the form of a flexible combination of functions of the data processing processes of the product model data.

A fourth step is the transformation of the semantized product model data into the neutral data of the product specification by means of the S4 orchestrated data processing processes based on the configured product specification.

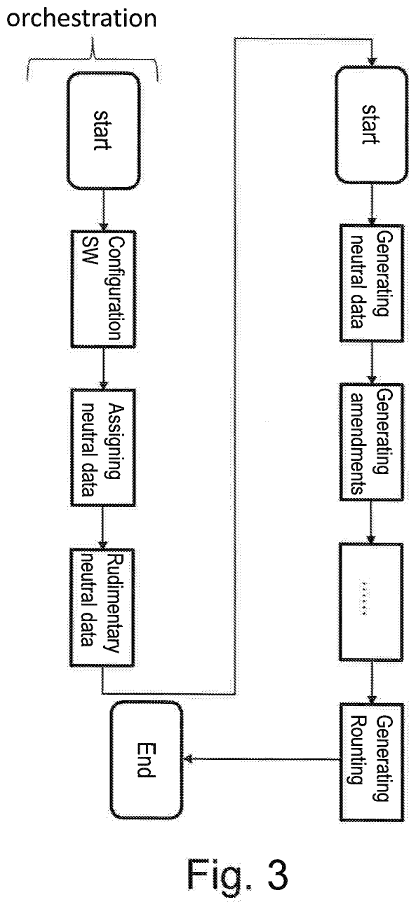

FIG. 3 shows a schematic representation of a process visualization of a process for generating neutral data for a product specification according to an embodiment of the present invention.

The overall process shown in FIG. 3 comprises a software module process shown in the right column and an orchestration process shown in the left column.

For example, the orchestration process may have a trigger mechanism where the report is called when a new sales document is available.

For example, the orchestration process may have a start condition, such as creating a sales document with a configured product, and the configuration is available as an item in the document.

For example, the orchestration process can be designed as a monitoring process and designed to generate neutral data for a product specification.

Although the present invention has been described above using preferred examples and embodiments, it is not limited to this, but can be modified in many ways. In particular, the invention can be altered or modified in many ways without deviating from the core of the invention.

In addition, it should be noted that “comprehensive” and “having” do not exclude any other elements or steps and “one” or “one” do not exclude any multiplicity.

1. A method for generating neutral data for a product specification, the method being carried out in a computer network and the method comprising the following method steps:
configuring (S1) and providing the product specification;
semantizing (S2) product model data for a plurality of different product specifications from a database into semantized product model data, the database providing a plurality of product model data by variant modeling;
orchestrating (S3) data processing processes of the product model data into orchestrated data processing processes; and
transforming (S4) of the semantized product model data using the orchestrated data processing processes based on the configured product specification to the neutral data of the product specification.

2. The method according to claim 1, wherein the method is executed by distributed processing in the computer network.

3. The method according to patent claim 1, wherein the product specification is at least one of the following:
i) a customer-specific product specification; and/or
(ii) a stock product specification; and/or
(iii) a new product specification.

4. The method according to claim 1, wherein configuring (S1) and providing the product specification is performed by a web configurator, a web shop, a simulation system, an enterprise resource planning system, a production control system, or an assembly auxiliary machine.

5. The method according to claim 1, wherein the product model data is semantized for the plurality of different product specifications based on an entity relationship model.

6. The method according to claim 1, wherein the variant modeling is provided by a web-based and/or interactive product configurator.

7. The method according to claim 1, wherein the neutral data is provided in a neutral data format, wherein the neutral data format is
(i) an XML format; and/or
(ii) a platform-independent data format; and/or
(iii) an implementation-independent data format; and/or
(iv) an M2M data format

8. The method according to claim 1, wherein for orchestrating (S3) the data processing processes the data processing services of a production plant and/or a backend system of the computer network are orchestrated.

9. An apparatus for generating neutral data in a computer network, the apparatus comprising:
a configuration module adapted to configure and provide a product specification;
a semantic module adapted to semanticize product model data for a plurality of different product specifications into semanticized product model data from a database coupled to the computer network, the database comprising a plurality of product model data generated by variant modeling;
an orchestration module adapted to orchestrate data processing processes of the product model data into orchestrated data processing processes; and
a transformation module adapted to transform semantized product model data to the neutral data of the product specification by means of the orchestrated data processing processes based on the configured product specification.

10. The apparatus according to claim 9, wherein the apparatus is formed as a distributed computer network.

11. The apparatus according to claim 9, wherein the configuration module is adapted to transform, as the product specification:
(i) a customer-specific product specification; and/or
(ii) a stock product specification; and/or
(iii) a new product specification

12. The apparatus according to claim 9, wherein the configuration module is adapted to perform configuration and provision of the product specification by a web configurator, a web shop, a simulation system, an enterprise resource planning system, a production control system, or an assembly auxiliary machine.

13. The apparatus according to claim 9, wherein the semantic module is adapted to semanticize the product model data for the plurality of different product specifications based on an entity relationship model.

14. The apparatus according to claim 9, wherein the apparatus is adapted to provide the neutral data in a neutral data format, the neutral data format comprising
(i) an XML format; and/or
(ii) a platform-independent data format; and/or
(iii) an implementation-independent data format; and/or
(iii) an M2M data format.

15. A computer network comprising the apparatus according to claim 9, further comprising a database having a web-based and/or interactive product configurator adapted to generate the plurality of product model data by the variant modelling.
